(19) United States
(12) Patent Application Publication
(10) Pub. No.: US 2026/0366972 A1
(43) Pub. Date: Nov. 19, 2026

(54) SEALING DEVICE FOR ROCK MASS SHEAR SEEPAGE TESTS

(71) Applicant: Institute of Geology and Geophysics, Chinese Academy of Sciences, Beijing (CN)

(72) Inventors: Wei LU, Beijing (CN); Shengwen QI, Beijing (CN); Ju WANG, Beijing (CN); Liang CHEN, Beijing (CN); Xingguang ZHAO, Beijing (CN); Jian LIU, Beijing (CN); Bowen ZHENG, Beijing (CN); Songfeng GUO, Beijing (CN); Guangming LUO, Beijing (CN); Xiaokun HOU, Beijing (CN); Yu ZOU, Beijing (CN); Ning LIANG, Beijing (CN); Weiwei ZHU, Beijing (CN); Zan WANG, Beijing (CN); Yidong XIAO, Beijing (CN); Xiao LU, Beijing (CN); Xiandong MA, Beijing (CN); Jianing CONG, Beijing (CN)

(73) Assignee: Institute of Geology and Geophysics, Chinese Academy of Sciences, Beijing (CN)

(21) Appl. No.: 19/676,686

(22) Filed: May 13, 2026

(30) Foreign Application Priority Data
May 14, 2025 (CN) 202510614661.1

(51) Int. Cl. G01N 3/04; G01N 3/24

(52) U.S. Cl. CPC G01N 3/04; G01N 3/24; G01N 2203/0025; G01N 2203/04

(57) ABSTRACT

A sealing device for rock mass shear seepage tests is provided, relating to the technical field of rock mass engineering geomechanical tests, including a sample clamping portion; a seepage sealing portion, arranged inside the sample clamping portion and having upper sealing assemblies and lower sealing assemblies, an upper sample being sealed between the two upper sealing assemblies, a lower sample being sealed between the two lower sealing assemblies, and the upper sealing assemblies and the lower sealing assemblies located on the same side being sealed; and stress loading portions, arranged on a top of the upper sample and a bottom of the lower sample, respectively, to apply stress to the upper sample and the lower sample. The sealing device for rock mass shear seepage tests provided by the present disclosure has a good sealing effect and meets the sealing requirements of rock mass shear seepage tests.

### CROSS-REFERENCE TO RELATED APPLICATIONS

The application claims priority to Chinese patent application No. 202510614661.1, filed on May 14, 2025, the entire contents of which are incorporated herein by reference.

### TECHNICAL FIELD

The present disclosure relates to the technical field of rock mass engineering geomechanical tests, and in particular to, a sealing device for rock mass shear seepage tests.

### BACKGROUND

A shear box is a commonly used rock mass shear test device, which is widely used to simulate rock mass shear behaviors. Due to the limitations of test conditions, the seepage sealing technology of the existing shear box still needs to be improved. The known technical solutions of the inventors are prone to sealing failure when the rock mass is displaced or deformed during actual tests, not adapting to the complex deformation during the rock mass shearing or fully meeting the sealing requirements of rock mass shear seepage tests. Therefore, there is an urgent need to develop a sealing device for rock mass shear seepage tests.

### SUMMARY

An objective of the present disclosure is to provide a sealing device for rock mass shear seepage tests, so as to solve the problems existing in the prior art. The sealing device has a good sealing effect and meets the sealing requirements of rock mass shear seepage tests.

To achieve the above objectives, the present disclosure provides the following solution:

The present disclosure provides a sealing device for rock mass shear seepage tests, including:
a sample clamping portion;
a seepage sealing portion, arranged inside the sample clamping portion and having upper sealing assemblies and lower sealing assemblies, an upper sample being sealed between the two upper sealing assemblies, a lower sample being sealed between the two lower sealing assemblies, and the upper sealing assemblies and the lower sealing assemblies located on the same side being sealed. A contact sealing method here is used to achieve the sealing between the upper sealing assemblies and the lower sealing assemblies located on the same side; and
stress loading portions, arranged on a top of the upper sample and a bottom of the lower sample, respectively, to apply stress to the upper sample and the lower sample.

Preferably, the sample clamping portion includes a first clamping block and a second clamping block that are arranged symmetrically, an upper portion of the first clamping block is connected to an upper portion of the second clamping block by a horizontally arranged first pull rod, a lower portion of the first clamping block is connected to a lower portion of the second clamping block by a horizontally arranged second pull rod, and both the seepage sealing portion and the stress loading portions are located between the first clamping block and the second clamping block.

Preferably, the upper sealing assemblies each include upper sealing modules symmetrically arranged on both sides of the upper sample, upper limiting pad blocks are arranged outside the upper sealing modules, one end of each of the upper limiting pad blocks is fixedly connected to the first clamping block or the second clamping block while the other end is provided with a trapezoidal boss, and rollers are arranged on a side wall of the trapezoidal boss; a groove with an inverted trapezoidal structure is arranged on one side of each of the upper sealing modules close to each of the upper limiting pad blocks, the trapezoidal boss is located in the groove, a gap is between a tail end of the trapezoidal boss and an inner bottom of the groove, and the rollers abut against a side wall of the groove.

Preferably, the upper sealing modules each include an upper sealing pad and an upper sealing pad block, one side of the upper sealing pad is sealed to the upper sample while the other side is fixedly attached to the upper sealing pad block, and the groove is provided on one side of the upper sealing pad block away from the upper sealing pad; a bottom of the upper sealing pad is sealed to tops of the lower sealing assemblies, and a top of the upper sealing pad is sealed to the stress loading portion located on a top of the upper sample.

Preferably, the first clamping block is threadedly connected to a first upper limiting bolt, the first upper limiting bolt is fixedly connected to the upper limiting pad block close to the first clamping block after extending through the first clamping block horizontally; and the second clamping block is threadedly connected to a second upper limiting bolt, the second upper limiting bolt is fixedly connected to the upper limiting pad block close to the second clamping block after extending through the second clamping block horizontally.

Preferably, the lower sealing assemblies each include lower sealing modules symmetrically arranged on both sides of the lower sample, lower limiting pad blocks are arranged outside the lower sealing modules, one end of each of the lower limiting pad blocks is fixedly connected to the first clamping block or the second clamping block while the other end is provided with a trapezoidal boss; a groove with an inverted trapezoidal structure is arranged on one side of each of the lower sealing modules close to each of the lower limiting pad blocks, the trapezoidal boss is located in the groove, and a gap is between a tail end of the trapezoidal boss and an inner bottom of the groove.

Preferably, the lower sealing modules each include a lower sealing pad and a lower sealing pad block, one side of the lower sealing pad is sealed to the lower sample while the other side is fixedly attached to the lower sealing pad block, and the groove is provided on one side of the lower sealing pad block away from the lower sealing pad; a top of the lower sealing pad is sealed to bottoms of the upper sealing assemblies, and a bottom of the lower sealing pad is sealed to the stress loading portion located on a bottom of the lower sample.

Preferably, the first clamping block is threadedly connected to a first lower limiting bolt, the first lower limiting bolt is fixedly connected to the lower limiting pad block close to the first clamping block after extending through the first clamping block horizontally; and the second clamping block is threadedly connected to a second lower limiting bolt, the second lower limiting bolt is fixedly connected to the lower limiting pad block close to the second clamping block after extending through the second clamping block horizontally.

Preferably, the stress loading portions each include an upper pressing head located on the top of the upper sample, a fixed shear pull head is wrapped outside the upper pressing head, a vertical projection of an inner side wall of the fixed shear pull head is collinear with a vertical projection of an outer side wall of the upper sample, a top of the upper sealing pad abuts against a bottom of the fixed shear pull head, a protrusion is arranged at a position where the bottom of the fixed shear pull head is close to the outer side wall of the upper sample, the protrusion is located between the upper sealing pad block and the upper sample, and the top of the upper sealing pad is fixedly abutted against a bottom of the protrusion.

Preferably, the stress loading portions each include a lower pressing head located on the bottom of the lower sample, a lower pad block is fixedly arranged at an upper portion outside the lower pressing head, a vertical projection of an inner side wall of the lower pad block is collinear with a vertical projection of an outer side wall of the lower sample, a bottom of the lower sealing pad abuts against a top of the lower pad block, a protrusion is arranged at a position where the top of the lower pad block is close to the outer side wall of the lower sample, the protrusion is located between the lower sealing pad block and the lower sample, and the bottom of the lower sealing pad is fixedly abutted against the top of the protrusion.

The present disclosure achieves the following technical effects compared to the prior art:

In the present disclosure, the sealing of the sample is achieved through the cooperative arrangement of the two upper sealing assemblies and two lower sealing assemblies. Since the upper sealing assemblies and the lower sealing assemblies are sealed but not fixedly connected, the upper sealing assemblies and the lower sealing assemblies can always maintain sealing when shear stress is applied between the upper sample and the lower sample. The sample is not prone to sealing failure when displaced or deformed, to adapt to the complex deformation during the rock mass shearing, and thus fully meeting the sealing requirements of the rock mass shear seepage tests.

### BRIEF DESCRIPTION OF DRAWINGS

To better clarify the embodiments of the present disclosure or the technical solution in the prior art, the accompanying drawings required to illustrate the embodiments will be simply described below. It is apparent that the accompanying drawings described below merely illustrate some embodiments of the present disclosure. Those of ordinary skill in the art can obtain other accompanying drawings without creative labor on the basis of those accompanying drawings.

FIG. 1 is a cross-sectional schematic diagram of a sealing device for rock mass shear seepage tests according to the present disclosure.

FIG. 2 is a schematic diagram of an upper sealing assembly according to the present disclosure.

FIG. 3 is a schematic diagram of a lower sealing assembly according to the present disclosure.

FIG. 4 is a partial enlarged schematic diagram of upper and lower sealing pads according to the present disclosure.

In the drawings: 1—First clamping block, 2—Upper pressing head, 3—Fixed shear pull head, 4—First upper sealing pad block, 5—First upper limiting pad block, 6—First upper limiting bolt, 7—First upper sealing pad, 8—First lower limiting pad block, 9—First lower limiting bolt, 10—First lower sealing pad block, 11—First lower sealing pad, 12—Lower pad block, 13—First pull rod, 14—Second clamping block, 15—Upper sample, 16—Second upper sealing pad, 17—Second upper sealing pad block, 18—Second upper limiting pad block, 19—Second upper limiting bolt, 20—Second lower limiting pad block, 21—Second lower limiting bolt, 22—Second lower sealing pad block, 23—Second lower sealing pad, 24—Lower sample, 25—Lower pressing head, 26—Second pull rod, 27—Roller, 28—Protrusion.

### DETAILED DESCRIPTION OF THE EMBODIMENTS

The technical solution in the embodiments of the present disclosure is clearly and completely elaborated below in combination with the accompanying drawings in the embodiments of the present disclosure. It is apparent that the described embodiments are only a part of the embodiments of the present disclosure but not all. Based on the embodiments of the present disclosure, all the other embodiments obtained by those of ordinary skill in the art on the premise of not contributing creative effort should belong to the protection scope of the present disclosure.

An objective of the present disclosure is to provide a sealing device for rock mass shear seepage tests, so as to solve the problems existing in the prior art. The sealing device has a good sealing effect and meets the sealing requirements of rock mass shear seepage tests.

In order to make the above-mentioned objectives, features and advantages of the present disclosure more apparent and understandable, the present disclosure will be further described in detail below with reference to the accompanying drawings and specific embodiments.

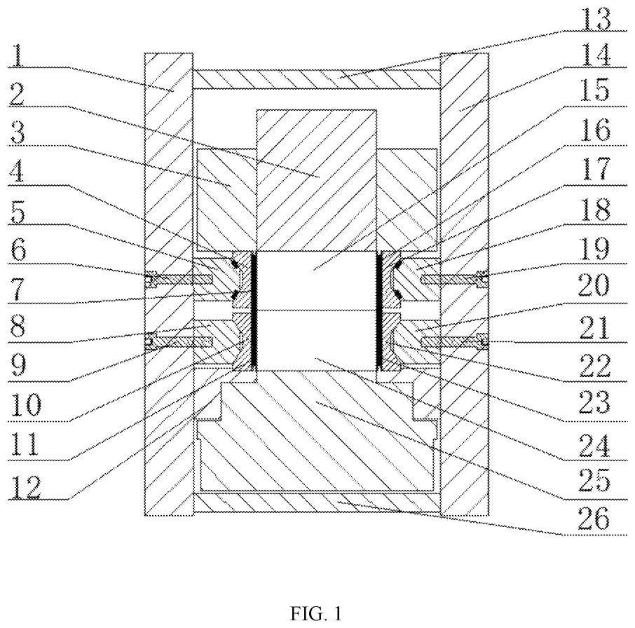

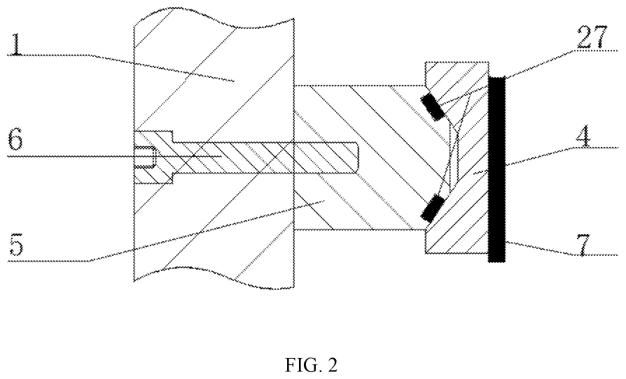

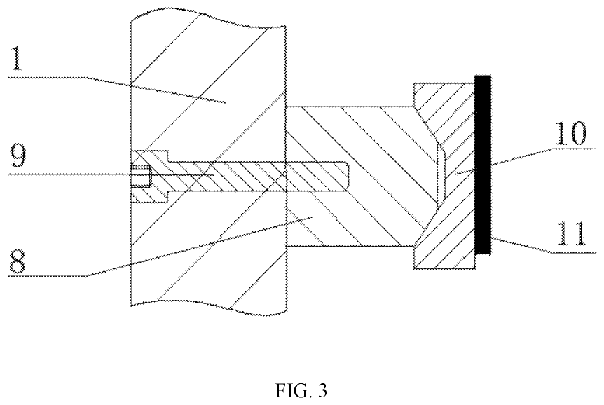

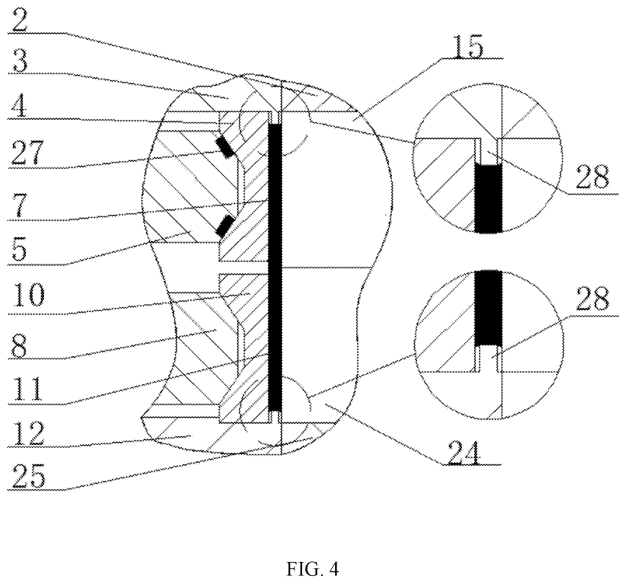

During the rock mass shear seepage test, shear force needs to be applied to the sample, causing the upper and lower samples to shift. Therefore, the test device known by the inventor cannot ensure the sealing performance during the test. In order to solve this problem, the present disclosure provides a sealing device for rock mass shear seepage tests, as shown in FIGS. 1, 2, 3 and 4, including a sample clamping portion, a seepage sealing portion, and stress loading portions. A first clamping block 1 and a second clamping block 14 of the sample clamping portion are connected by an upper first pull rod 13 and a lower second pull rod 26, to control the integrity of the test device. The seepage sealing portion is located inside the sample clamping portion and has upper sealing assemblies and lower sealing assemblies. An upper sample 15 is sealed between the two upper sealing assemblies, a lower sample 24 is sealed between the two lower sealing assemblies, and the upper sealing assemblies and the lower sealing assemblies located on the same side are sealed. The stress loading portions are located on a top of the upper sample 15 and a bottom of the lower sample 24, respectively, which can apply stress to the upper sample 15 and the lower sample 24. By applying normal prestress to the upper sample 15, the lower sample 24, the upper sealing assemblies, and the lower sealing assemblies, the upper sealing assemblies and the lower sealing assemblies can achieve a good sealing effect on the sample, and the contact ends of the upper sealing assemblies and the lower sealing assemblies can also ensure the sealing performance. When shear force is applied to the sample, the upper sealing assemblies and the lower sealing assemblies can be ensured to in the appropriate contact position and have good sealing performance.

In order to ensure the sealing performance even when shear force is applied, an upper pressing head 2 is provided on the top of the upper sample 15. The upper pressing head 2 can apply a normal preload force to the sample. A fixed shear pull head 3 is wrapped outside the upper pressing head 2. A vertical projection of an inner side wall of the fixed shear pull head 3 is collinear with a vertical projection of an outer side wall of the upper sample 15, such that the fixed shear pull head 3 can apply horizontal shear force to the upper sample 15. When the shear force is applied, in order to avoid damaging the sealing performance, in this embodiment, the upper sealing assemblies each include upper sealing modules symmetrically arranged on both sides of the upper sample 15. The two upper sealing modules each include a first upper sealing pad block 4 and a second upper sealing pad block 17. A first upper sealing pad block 5 is arranged outside the first upper sealing pad block 4. One end of the first upper sealing pad block 5 is fixedly connected to the first clamping block 1 while the other end is provided with a trapezoidal boss. A second upper limiting pad block 18 is arranged outside the second upper sealing pad block 17. One end of the second upper limiting pad block 18 is fixedly connected to the second clamping block 14 while the other end is provided with a trapezoidal boss. Rollers 27 are arranged on a side wall of the trapezoidal boss. In this embodiment, the upper sealing modules adopt a structure in which an upper sealing pad cooperates with an upper sealing pad block. A smooth surface inside the first upper sealing pad 7 abuts against the outer side wall of the upper sample 15. A smooth surface outside the first upper sealing pad 7 is tightly connected to a smooth surface inside the first upper sealing pad block 4. A groove with an inverted trapezoidal structure is provided outside the first upper sealing pad block 4, and the trapezoidal boss is located in the corresponding groove. A gap is provided between a tail end of the trapezoidal boss and an inner bottom of the groove, allowing the first upper sealing pad block 4 to deform in a direction perpendicular to the inverted trapezoidal side wall under the action of force. At this time, the first upper sealing pad block 4 squeezes the first upper sealing pad 7 on the right side, such that both the upper inner side and the lower inner side of the first upper sealing pad 7 are tightly adhered to the upper sample 15, thereby forming a good sealing performance. Meanwhile, since the first upper limiting pad block 5 and the first upper sealing pad block 4 are in contact with rollers 27, the frictional resistance is greatly reduced during their relative movement, ensuring the accuracy of the test results. Specifically, the first upper limiting pad block 5 can horizontally and inwardly squeeze the first upper sealing pad block 4, thereby making the first upper sealing pad 7 tightly connected to the outer side wall of the upper sample 15, improving the sealing performance. Since the rollers 27 abut against the side wall of the groove, when the shear force is applied, the rollers 27 and the side wall of the groove can roll relative to each other, that is, the first upper sealing pad block 4 and the first upper sealing pad 7 can move synchronously with the upper sample 15 along the direction of shear force, and horizontal pressure is always applied outside the first upper sealing pad block 4 and the first upper sealing pad 7 by the rollers 27 of the first upper limiting pad block 5, ensuring that the first upper sealing pad 7 is capable of sealing the upper sample 15 all the time. The working principle of the second upper sealing pad 16 is the same as that of the first upper sealing pad 7, so no repetitions are made here.

In order to make the horizontal contact preload force applied by the sealing pad to the sample adjustable, in this embodiment, the first clamping block 1 is threadedly connected to a first upper limiting bolt 6, the first upper limiting bolt 6 is fixedly connected to the upper limiting pad block 5 close to the first clamping block 1 after extending through the first clamping block 1 horizontally. The second clamping block 14 is threadedly connected to a second upper limiting bolt 19, the second upper limiting bolt 19 is fixedly connected to the upper limiting pad block 18 close to the second clamping block 14 after extending through the second clamping block 14 horizontally. By tightening the first upper limiting bolt 6 and the second upper limiting bolt 19, a horizontal force towards the sample can be applied to the first upper limiting pad block 5 and the second upper limiting pad block 18.

In order to make the sealing performance between the stress loading portions and the first upper sealing pad 7 and the second upper sealing pad 16 better, in this embodiment, the tops of the first upper sealing pad block 4 and the second upper sealing pad block 17 abut against the bottom of the fixed shear pull head 3, respectively. A protrusion 28 is arranged at a position where a bottom of the fixed shear pull head 3 is close to the outer side wall of the upper sample 15, an upper first protrusion 28 is arranged between the first upper sealing pad block 4 and the upper sample 15, and an upper second protrusion 28 is arranged between the second upper sealing pad block 17 and the upper sample 15. A top of the first upper sealing pad 7 is fixedly abutted against a bottom of the upper first protrusion 28, and a top of the second upper sealing pad 16 is fixedly abutted against a bottom of the upper second protrusion 28, thus ensuring the sealing effect here.

In one specific embodiment, a lower pressing head 25 and a lower pad block 12 are arranged on the bottom of the lower sample 24. The lower pad block 12 is fixed to an upper portion outside the lower pressing head 25, and a vertical projection of an inner side wall of the lower pad block 12 is collinear with a vertical projection of the outer side wall of the lower sample 24. The lower sealing assemblies each include lower sealing modules symmetrically arranged on both sides of the lower sample 24. The lower sealing modules each include a first lower sealing pad block 10 and a second lower sealing pad block 22. The first lower limiting pad block 8 is arranged outside the first sealing pad block 10. One end of the first lower limiting pad block 8 is fixedly connected to the first clamping block 1 while the other end is provided with a trapezoidal boss. The second lower limiting pad block 20 is arranged outside the second lower sealing pad block 22, and one end of the second lower limiting pad block 20 is fixedly connected to the second clamping block 14 while the other end is provided with a trapezoidal boss, and a side wall of the trapezoidal boss is smooth. In this embodiment, the lower sealing modules adopt a structure in which the lower sealing pad cooperates with the lower sealing pad block. A smooth surface inside the first lower sealing pad 11 abuts against the outer side wall of the lower sample 24. A smooth surface outside the first lower sealing pad 11 is tightly connected to a smooth surface inside the first lower sealing pad block 10. A groove with an inverted trapezoidal structure is provided outside the first lower sealing pad block 10, and the trapezoidal boss is located in the corresponding groove. A gap is provided between a tail end of the trapezoidal boss and an inner bottom of the groove, allowing the first lower sealing pad block 10 to deform in a direction perpendicular to the inverted trapezoidal side wall under the action of force. At this time, the first lower sealing pad block 10 squeezes the first lower sealing pad 11 on the right side, such that both the upper inner side and the lower inner side of the first lower sealing pad 11 are tightly adhered to the lower sample 24, thereby forming a good sealing performance.

Specifically, the first lower limiting pad block 8 can horizontally and inwardly squeeze the first lower sealing pad block 10, thereby making the first lower sealing pad 11 tightly connected to the outer side wall of the lower sample 24, improving the sealing performance. A top of the trapezoidal boss of the first lower limiting pad block 8 is not in contact with a bottom of the inverted trapezoidal groove of the first lower sealing pad block 10, causing the first lower sealing pad block 10 to deform in a direction perpendicular to the inverted trapezoidal side wall under the action of force. No relative movement is between the first lower limiting pad block 8 and the first lower sealing pad block 10. At this time, the first lower sealing pad block 10 squeezes the first lower sealing pad 11 on the right side, such that the upper and lower portions of the first lower sealing pad 11 are tightly adhered to the lower sample 24, and the top of the first lower sealing pad 11 is fixedly sealed and abutted against the bottom of the first upper sealing pad, thereby forming a good sealing performance. The working methods of the second lower sealing pad 23, the second lower sealing pad block 22, and the second lower limiting pad block 20 are not repeated in detail.

In order to make the horizontal contact preload force applied by the sealing pad to the sample adjustable, in this embodiment, a lower portion of the first clamping block 1 is threadedly connected to a first lower limiting bolt 9, and the first lower limiting bolt 9 is fixedly connected to the first lower limiting pad block 8 close to the first clamping block 1 after extending through the first clamping block 1 horizontally. The second clamping block 14 is threadedly connected to a second lower limiting bolt 21, and the second lower limiting bolt 21 is fixedly connected to the second lower limiting pad block 20 close to the second clamping block 14 after extending through the second clamping block 14 horizontally. By turning the first lower limiting bolt 9 and the second lower limiting bolt 21, a horizontal force towards the sample can be applied to the first lower limiting pad block 8 and the second lower limiting pad block 20.

In order to make the sealing performance between the stress loading portions and the first lower sealing pad 11 and the second lower sealing pad 23 better, in this embodiment, the bottoms of the first lower sealing pad block 10 and the second lower sealing pad block 22 abut against the top of the lower pad block 12, respectively. A protrusion 28 is arranged at a position where a top of the lower pad block 12 is close to the outer side wall of the lower sample 24, a lower first protrusion 28 is arranged between the first lower sealing pad block 10 and the lower sample 24, and a lower second protrusion 28 is arranged between the second lower sealing pad block 22 and the upper sample 24. A bottom of the first lower sealing pad 11 is fixedly abutted against a top of the lower first protrusion 28, and a bottom of the second lower sealing pad 23 is fixedly abutted against a top of the lower second protrusion 28, thus ensuring the sealing effect here.

Under the action of force, the first upper sealing pad 7 is in close contact with the first upper sealing pad block 4 on the left side and the upper sample 15 on the right side. Under the pressure of the protrusion 28 of the fixed shear pull head 3, the first upper sealing pad 7 is pressed down and comes into close contact with the first lower sealing pad 11. At the same time, the upper end of the first upper sealing pad 7 is pressed by the protrusion 28, deforms to both sides of the protrusion 28, and extends into the gap between the protrusion 28 and the first upper sealing pad block 4 as well as the gap between the protrusion 28 and the upper sample 15, further forming a good seal performance. The first upper sealing pad 7 and the first lower sealing pad 11 are made of polytetrafluoroethylene, which results in less friction when moving relative to each other, thus improving the accuracy of the test results. The principles and structures of the second upper sealing pad 16, the first lower sealing pad 11, and the second lower sealing pad 23 are the same as those of the first upper sealing pad 7, so no repetitions are made here.

Specific examples are applied in the present disclosure to set forth the principles and embodiments of the present disclosure, and the description of the above embodiment is merely used to help understand the method and its core concept of the present disclosure; at the same time, the concepts of those of ordinary skill in the art based on the present disclosure will be changed in the specific embodiments and the application scopes. In conclusion, the contents of the specification shall not be understood as a limitation to the present disclosure.

What is claimed is:

1. A sealing device for rock mass shear seepage tests, comprising:
a sample clamping portion;
a seepage sealing portion, arranged inside the sample clamping portion and having upper sealing assemblies and lower sealing assemblies, an upper sample being sealed between the two upper sealing assemblies, a lower sample being sealed between the two lower sealing assemblies, and the upper sealing assemblies and the lower sealing assemblies located on the same side being sealed;
stress loading portions, arranged on a top of the upper sample and a bottom of the lower sample, respectively, to apply stress to the upper sample and the lower sample;
wherein the sample clamping portion comprises a first clamping block and a second clamping block that are arranged symmetrically, an upper portion of the first clamping block is connected to an upper portion of the second clamping block by a horizontally arranged first pull rod, a lower portion of the first clamping block is connected to a lower portion of the second clamping block by a horizontally arranged second pull rod, and both the seepage sealing portion and the stress loading portions are located between the first clamping block and the second clamping block;
the upper sealing assemblies each comprise upper sealing modules symmetrically arranged on both sides of the upper sample, upper limiting pad blocks are arranged outside the upper sealing modules, one end of each of the upper limiting pad blocks is fixedly connected to the first clamping block or the second clamping block while the other end is provided with a trapezoidal boss, and rollers are arranged on a side wall of the trapezoidal boss; a groove with an inverted trapezoidal structure is arranged on one side of each of the upper sealing modules close to each of the upper limiting pad blocks, the trapezoidal boss is located in the groove, a gap is between a tail end of the trapezoidal boss and an inner bottom of the groove, and the rollers abut against a side wall of the groove;
the upper sealing modules each comprise an upper sealing pad and an upper sealing pad block, one side of the upper sealing pad is sealed to the upper sample while the other side being fixedly attached to the upper sealing pad block, and the groove is provided on one side of the upper sealing pad block away from the upper sealing pad; a bottom of the upper sealing pad is sealed to tops of the lower sealing assemblies, and a top of the upper sealing pad is sealed to the stress loading portion located on a top of the upper sample;
the stress loading portions each comprise an upper pressing head located on the top of the upper sample, a fixed shear pull head is wrapped outside the upper pressing head, a vertical projection of an inner side wall of the fixed shear pull head is collinear with a vertical projection of an outer side wall of the upper sample, a top of the upper sealing pad block abuts against a bottom of the fixed shear pull head, a protrusion is arranged at a position where the bottom of the fixed shear pull head is close to the outer side wall of the upper sample, the protrusion is located between the upper sealing pad block and the upper sample, and the top of the upper sealing pad is fixedly abutted against a bottom of the protrusion;
an upper end of the first upper sealing pad is pressed by the protrusion, deforms to both sides of the protrusion, and extends into a gap between the protrusion and the first upper sealing pad block as well as a gap between the protrusion and the upper sample;
the first upper sealing pad block and the first upper sealing pad are capable of moving synchronously with the upper sample along a shear force direction, and horizontal pressure is always applied outside the first upper sealing pad block and the first upper sealing pad by the rollers of a first upper limiting pad block, ensuring that the first upper sealing pad is capable of sealing the upper sample all the time;
the lower sealing assemblies each comprise lower sealing modules symmetrically arranged on both sides of the lower sample, lower limiting pad blocks is arranged outside the lower sealing modules, one end of each of the lower limiting pad blocks is fixedly connected to the first clamping block or the second clamping block while the other end is provided with a trapezoidal boss; a groove with an inverted trapezoidal structure is arranged on one side of each of the lower sealing modules close to each of the lower limiting pad blocks, the trapezoidal boss is located in the groove, and a gap is between a tail end of the trapezoidal boss and an inner bottom of the groove; and
the lower sealing modules each comprise a lower sealing pad and a lower sealing pad block, one side of the lower sealing pad is sealed to the lower sample while the other side is fixedly attached to the lower sealing pad block, and the groove is provided on one side of the lower sealing pad block away from the lower sealing pad; a top of the lower sealing pad is sealed to bottoms of the upper sealing assemblies, and a bottom of the lower sealing pad is sealed to the stress loading portion located on a bottom of the lower sample.

2. The sealing device for rock mass shear seepage tests according to claim 1, wherein the first clamping block is threadedly connected to a first upper limiting bolt, the first upper limiting bolt is fixedly connected to the upper limiting pad block close to the first clamping block after extending through the first clamping block horizontally; and the second clamping block is threadedly connected to a second upper limiting bolt, the second upper limiting bolt is fixedly connected to the upper limiting pad block close to the second clamping block after extending through the second clamping block horizontally.

3. The sealing device for rock mass shear seepage tests according to claim 1, wherein the first clamping block is threadedly connected to a first lower limiting bolt, the first lower limiting bolt is fixedly connected to the lower limiting pad block close to the first clamping block after extending through the first clamping block horizontally; and the second clamping block is threadedly connected to a second lower limiting bolt, the second lower limiting bolt is fixedly connected to the lower limiting pad block close to the second clamping block after extending through the second clamping block horizontally.

4. The sealing device for rock mass shear seepage tests according to claim 1, wherein the stress loading portions each comprise a lower pressing head located on the bottom of the lower sample, a lower pad block is fixedly arranged at an upper portion outside the lower pressing head, a vertical projection of an inner side wall of the lower pad block is collinear with a vertical projection of an outer side wall of the lower sample, a bottom of the lower sealing pad abuts against a top of the lower pad block, a protrusion is arranged at a position where the top of the lower pad block is close to the outer side wall of the lower sample, the protrusion is located between the lower sealing pad block and the lower sample, and the bottom of the lower sealing pad is fixedly abutted against the top of the protrusion.
